(19) United States
(12) Patent Application Publication
(10) Pub. No.: US 2015/0304269 A1
(43) Pub. Date: Oct. 22, 2015

(54) SYSTEM AND METHOD

(71) Applicants: Gaurav KEERTHI, Singapore (SG); Pei Yu PAO, Singapore (SG)

(72) Inventors: Gaurav KEERTHI, Singapore (SG); Pei Yu PAO, Singapore (SG)

(21) Appl. No.: 14/689,941

(22) Filed: Apr. 17, 2015

Related U.S. Application Data
(60) Provisional application No. 61/982,083, filed on Apr. 21, 2014.

(51) Int. Cl. H04L 12/58; G07C 13/00

(52) U.S. Cl. CPC H04L 51/32; G07C 13/00

(57) ABSTRACT

A system and method is provided for managing text-based communication between visitors of a website. In particular, the invention relates to a system and method for managing online comments contributed by these visitors. More particularly, but not exclusively, there is provided a system for processing online comments associated with electronic content, the system comprising one or more processor is configured to assign a comment to one of at least two options, the at least two options relate to at least two potential viewpoints associated with the electronic content. The method comprising assigning a comment to one of at least two options, the at least two options relate to at least two potential viewpoints associated with the electronic content.

### CROSS-REFERENCE TO RELATED APPLICATIONS

This application claims priority under 35 U.S.C. 119(e) to U.S. Provisional Patent Application No. 61/982,083, filed Apr. 21, 2014, which is incorporated by reference herein in its entirety.

### INTRODUCTION

This invention is related to a system and method for managing text-based communication between visitors of a website. In particular, the invention relates to a system and method for managing online comments contributed by these visitors.

Conventional methods to facilitate text-based communication between website visitors and website owners utilize a digital form with blank fields that enables a visitor to leave a text-based response (a “comment”) to some sort of content created by the owner of the website, or to a topic in an online discussion board. The visitor-submitted comment is then displayed together with other user-submitted comments. If the comments are on a website, they are usually placed below the main content (which can be in the form of a text-based article, a video, an image, or any other form of digital content). If the comments are on an online multi-topic discussion board, they are placed together with all other comments on the same topic.

These visitor-submitted comments can be sorted chronologically (newest comments first or oldest comments first) or by rank-order (based on some sort of peer-voting mechanism where comments that are subjectively assessed by another visitor to be better can be scored higher). Presently, a visitor must read each individual comment (regardless of sorting order) in order to comprehend the whole discussion.

Most commenting systems presently also are only able to display comments as a long list, sorted chronologically or by rank-order (using some form of peer-voting mechanism). There is presently no way for a visitor to quickly analyze and comprehend the content of a large number of comments. Furthermore, there is no quick way for a visitor to conduct analysis on the content of a large set of comments on a website, to determine what the opinion of the majority of commenters is. This is especially true in discussions on contentious questions or topics (in which not all the commenters share the same point of view on the topic being discussed). Therefore, a need exists for a system and method that can automatically summarize, visually sort and create a synthesis from the content of a large number of comments, in a way that facilitates faster comprehension by the website visitor.

The listing or discussion of an apparently prior-published document in this specification should not necessarily be taken as an acknowledgement that the document is part of the state of the art or is common general knowledge.

Any document referred to herein is hereby incorporated by reference in its entirety.

In accordance with a first aspect of the present invention, there is provided a system for processing online comments associated with electronic content, the system comprising one or more processor that is configured to assign a comment to one of at least two options, the at least two options relating to at least two potential viewpoints associated with the electronic content.

Preferably, the system includes any suitable hardware that is adapted to carry out the method of managing the online comments. By “processor”, it is meant to include any hardware within a computer that executes a program. In one embodiment, the system may include at least one processor, an input/output (I/O) interface, and a memory. The at least one processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions or modules stored in the memory. An example of such a processor may be an ASIC.

By “electronic content”, it is meant to include any content that may be associated with a product, a service or a cause. As such, it follows, that by “comments”, it is meant to include any response that is submitted by any one (for example, any member of the public reading the electronic content, or any registered user of a website hosting the electronic content). The response may be any opinion or thought that is associated with the electronic content. These comments may take any form, for example a text, image, video, an audio etc.

The Internet consists of websites which contain content (which can be in the form of a text-based article, a video, an image, or any other form of digital content) that is either created or managed by the owner(s) of the website. Often, the owner(s) of a website wish to prompt discussion, seek feedback, or get input on this content from the visitors to their website. There are multiple ways to accomplish this, including but not limited to email forms (in which the visitor-submitted text goes directly to the owner's email account), polls (in which visitors vote on specific response options), and comment forms (in which a visitor uses a digital form on the website that contains blank fields that can be filled in with a text-based comment and submitted to be displayed with other comments on the website). Comment forms are prevalent on personal websites (such as “blogs”), commercial websites that assist in the sale or promotion of products or services, and news or magazine websites that feature articles and stories on various issues.

A “commenting system” or “commenting tool” in this context is thus any internet-based software that allows a website owner to place such a digital form with blank fields on their website, and where the visitor-submitted contents of that form are then displayed on the website itself, together with (or below) the original content of the website. Typically, most commenting systems have four main fields in the form that the visitor can fill in: the visitor's name, the visitor's email address, the visitor's website address, and the visitor's comment. Commenting systems tend to contextualize the form as an open-ended invitation for the visitor to “Leave a Response” or “Add a Comment.”

The two options available for assignment may be any two potential viewpoints that are associated with the electronic content. By “viewpoints”, it is meant to include any views, perspectives, standpoints, positions or opinions that a commenter may have in respond to the electronic content. For example, if the electronic content is a question, then the at least two options may be possible answers to the question. There may be more than two options available, and a commenter may also create more options he/she thinks may be relevant to the electronic content.

The system of the present invention also allows others to submit responses to comments that earlier submitted and have been published. These responses may be in the form of further comments in response to a comment. In addition, anyone reading the comments may either vote in favour of (to agree) or otherwise (for example, to disagree) in respond to a comment.

In an embodiment, the one or more processor is further configured to determine a profile of a commenter by determining if the commenter's comment receives a response from at least one respondent and, if it does, analysing said response, the analysis comprising (a) if the response is a vote to agree or disagree, determining the number of votes; and/or (b) if the response is a further comment, determining which option the respondent's comment belongs to. Preferably, the one or more processor is further configured to determine whether the voter providing the vote had provided a comment, and determining which option said comment belongs to. Alternatively, if the voter had not provided a comment, the processor may be configured to monitor the voter to determine if he provides a comment to the electronic content at a later time, and determine which option the comment is assigned to.

By “profile”, it is meant to include any representation, qualities or characteristics of the commenter. For example, whether the commenter has moderate views, divisive views, and/or whether the commenter has influence and is an opinion leader.

The system may be configured to analyse the responses contributed by the respondents. For example, in the case where votes have been received in response to a comment, the system is configured to determine whether the voter had previously posted a comment, and determining which option the comment was assigned to, i.e. what viewpoint the commenter holds. Advantageously, based on the quality of the comments (i.e. their position in the grid in a representation of the analysis carried out on the comments—which will be described later) and the voting patterns (i.e. which comments are getting favourable, or unfavourable, votes, and whether these votes come from opposing viewpoints), the system can then determine the trajectory of the conversation and discussion and how specific comments impact on the discussion thread. As such, by tracking which option the comments belong to (and hence, the quality, perspective and opinions of comments), the number of votes each comment receives, and whether these votes come from comments having opposing viewpoints, the system can determine through a combination of algorithms such as historical analysis and trajectory projection whether a commenter's opinion is moderate, persuasive and/or whether the commenter is an opinion leader.

By “determining the trajectory of the discussion”, it is meant to include any analysis of the comments to determine where public opinion lie and, taking a step further, determine the direction of the discussion and identifying the commenters that drive the direction of the discussion. This can be achieved by first determining the number and magnitude of comments that hold a particular viewpoint, i.e. by determining the number of comments in a particular option. For ease of description, these comments may be termed as “primary comments” and their commenters “primary commenters”. If these “primary comments” attract responses from other commenters (“respondents”) by way of a vote (that agrees or disagrees) or further comments, the system can analyse the quality of these votes and comments from these respondents to order to determine which “primary comments, and hence “primary commenters”, are persuasive, influential, moderate, divisive or simply have no effect on the discussion thread.

For example, in the case where a “primary comment” receives votes that agree with its viewpoint, then the present system will take the additional step of determining whether these votes came from respondents that have the same or similar viewpoints, or having opposing viewpoints. This can be determined by analysing whether these respondents had contributed to earlier comments and further determining which option these earlier comments were assigned to. As such, if the favourable votes came from respondents having opposing viewpoints, then this shows that the “primary commenter” provided a “primary comment” that is persuasive enough to receive a support from someone who holds an opposing viewpoint. Thus, such a “primary commenter” will have the profile of an opinion leader assigned to him.

Similary, if the “primary commenter” provided a “primary comment” that has not been agreed upon by other respondents, then the profile of the “primary commenter” is one that is not persuasive. This shows that he is not a opinion leader.

If, for example, the “primary commenter” provided a “primary comment” that attracts a high proportion of votes from both options (or sides) of possible viewpoints, then that “primary commenter” will have the profile of one that is divisive on public opinion.

The quality of the respondent's comments may be determined by having the one or more processor being configured to assign an option to it and, thus, determining the opinion of the respondent. Alternatively, or in addition, the respondent may select a relevant option to assign his comment to.

The system thus allows for the dynamic tracking of the progression of the discussion through the comments that are received (as and when they are received) and, hence, determine the trajectory profile of the discussion thread. In an embodiment of the present invention, the profile of a commenter may include a score wherein the score represents whether the commenter is persuasive, influential, moderate or divisive. This score may be determined based on the number of comments contributed by the commenter, the quality of the comments (including the length of the comment, whether the comments contributed are focussed on the topic of the associated electronic content, whether the comments meet pre-determined sentence structure and the like), the responses that the comments elicit, the quality of these responses, and whether respondents agree with the viewpoint held by the commenters. For example, the score may be a percentage of comments that receive the most number or magnitude of response in comparison with the total number of comments posted by the commenter.

In an embodiment of the present invention, the one or more processor of the present system may be further configured to determine a trajectory profile of the online discussion. As such, the system is able to track user voting behaviour over time to run analytical algorithms to determine the persuasiveness of a comment in a conversation. That is, when a comment receives a vote from a user, the system can analyse its database and process the information to determine the previous opinions of the user on the same topic; if the database indicates that user was previously against the topic but now gives a vote for a comment in favour of the topic, then it is clear that this comment has persuaded him to change his opinion. This analytics can be performed for a large number of users over a large number of comments within a conversation, in order to determine which comments had the most persuasive impact on the most number of users. This portion of the analytics requires the rapid searching and processing of historical data on many users in the database, determination on their opinions by analysing their past voting and commenting behaviour in that conversation, and subsequently mathematically determining a persuasiveness score for the comment and storing it in the database. Using this persuasiveness score, the system is then able to determine which users in the database have a history of leaving the most persuasive comments (the “opinion shapers”). Furthermore, the system is able to analyse the text content of the most persuasive comments to determine some parameters of what makes a comment persuasive (such as the complexity of the sentence structure, the vocabulary, the use of references in the form of links, etc.).

The system is able to track user voting behaviour over time to run analytical algorithms to determine how moderate a particular user is over multiple conversations over time. That is, when a user participates in many conversations by commenting or voting, the system can analyse its database and process the information to determine whether the user has a history of only supporting one side in a discussion, or whether the user has a history of supporting multiple sides in a discussion. That is, whether the user has given votes or left comments only on one side in all his previous conversations, or has left votes and comments on both sides in previous conversations. These analytics can be performed on a large number of users over a large number of conversations over time, in order to determine who are the more moderate or balanced users. This portion of the analytics requires rapid searching and processing of historical data on many users in the database, determination of their past behaviour, and subsequently mathematically determining a score for their moderateness and storing this in the database.

In an embodiment, the options are pre-determined and may be set by the host of the system or author of the electronic content. The system may analyse the comments that are contributed by commenters and then assign each comment to the most relevant option.

In an alternative embodiment, the one or more processor provides the at least two options to a commenter for the commenter's selection and the commenter assigns his comments to one of the at least two options, or selects the relevant option.

Preferably, each option further comprises at least one pre-determined category associated with the option. The one or more processor may then be configured to further assign the comment to a pre-determined category. Alternatively, the one or more processor provides the at least one pre-determined category for the commenter's selection and the commenter assigns his comments to one pre-determined category.

This enables the system to provide a representation of the analysed and processed comments. By “representation”, it is meant to include any report for presentation of the summarised comments—which includes any visual charts, graphs or the like. The representation may take the form of (a) a matrix or grid having columns and rows; and (b) each column represents an option and each row represents a category, wherein a comment that corresponds to the respective column and row is assigned a position in the grid. The representation may further comprise a summary and/or background of the electronic content and include a listing of all comments. Advantageously, by providing the representation in accordance with a format provided by an embodiment of the present invention, one can quickly analyse the trajectory of the discussion thread.

Preferably, the system further comprises a database of pre-determined keywords and assigning of the comment to the option or pre-determined category is based on the pre-determined keywords.

Preferably, the one or more processor is further configured to determine the number of the comments within an option and rank the comments based on the number of the comments and optionally also to account for the magnitude of support for each of those comments (as expressed through user-contributed “votes” for each comment) in each option to generate a hierarchical presentation of the comments. In other words, the processor should preferably have the option to rank the comments based on the number of comments and the popular support (as expressed by the number of favourable votes it receives) for that comment.

In an embodiment, the one or more processor is further configured to only receive a comment if the comment meets any pre-determined characteristic selected from the group comprising: a pre-determined word number, a pre-determined sentence structure and whether the comment is associated with the electronic content. For example, the one or more processor of the system may be further configured to only receive a comment if the comment meets pre-determined characteristics and qualities such as: whether the comment is of sufficient length (for example, whether the comment meets a pre-determined word number); whether the comment is grammatically correct and is free of spelling errors (for example, whether the comment meets a pre-determined sentence structure) or whether the comment is focussed on the point of the electronic content and associated with the electronic content.

As such, in order to do this, the system may comprise a database of pre-determined keywords and assigning of a comment to a relevant option or a relevant pre-determined category is based on the matching of these pre-determined keywords.

Preferably, the one or more processor is further configured to receive the comments over a network. Preferably, the one or more processor is further configured to store the comments over a network.

In addition to the above, the commenters may be registered users of the system and the one or more processor is configured to determine the behavioural pattern of a registered user based on the user's past comments and voting patterns.

In a second aspect of the present invention, there is provided a method for processing online comments associated with electronic content, the method comprising assigning a comment to one of at least two options, the at least two options relate to at least two potential viewpoints associated with the electronic content. Advantageously, the method of the present invention analyses the database of comments in order to determine insights such as which comment was most persuasive, which comments were most divisive, which users were most moderate, which users were most influential, and determine the historical trajectory of the balance between the viewpoints or categories in the conversation over time, in order to present these insights as part of the synthesis.

Preferably, the method allows for further comments to be received in response to a comment. In addition, the method may also allow for users to vote in response to a comment. Importantly, the method includes the step of determining if the voter had previously submitted a comment, and determining which option the comment was assigned to. Advantageously, the method allows the determination of a trajectory profile of the online discussion—which is based on the quality (i.e. content and viewpoint held by a comment) and the responses it receives.

In particular, the method further comprises determining a profile of a commenter by determining if the commenter's comment receives a response from at least one respondent and, if it does, analysing said response, the analysis comprising (a) if the response is a vote to agree or disagree, determining the number of votes; and/or (b) if the response is a further comment, determining which option the respondent's comment belongs to. Preferably, the method further includes the step of determining whether the voter providing the vote had provided a comment, and determining which option said comment belongs to. Alternatively, if the voter had not provided a comment, the processor may be configured to monitor the voter to determine if he provides a comment to the electronic content at a later time, and determine which option the comment is assigned to.

In an alternative embodiment, the method includes the step of providing the at least two options to a commenter for the commenter's selection and the commenter assigns his comments to one of the at least two options.

Preferably, each option may comprise at least one pre-determined category associated with the viewpoint. The method further includes assigning the comment to a pre-determined category.

Preferably, the method includes determining the number of the comments within an option and rank the comments based on the magnitude of the comments and optionally also to account for the magnitude of support for each of those comments (as expressed through user-contributed “votes” for each comment) in each option to generate a hierarchical presentation of the comments.

Preferably, the method includes providing a representation of the analysed and processed comments. The representation may comprise (a) a grid having columns and rows; and (b) each column represents an option and each row represents a category, wherein a comment that corresponds to the respective column and row is assigned a position in the grid.

Preferably, the method includes the step of receiving and/or accepting a comment if the comment meets any pre-determined characteristic selected from the group comprising: a pre-determined word number, a pre-determined sentence structure and whether the comment is associated with the electronic content.

Preferably, the method includes determining a profile or behavioural pattern of a commenter based on the commenter's past comments and voting patterns.

In a third aspect of the present invention, there is provided a computer readable medium having instructions stored therein, the instructions when executed on a machine cause the machine to perform the method in accordance with the second aspect of the present invention.

The present invention provides a method and system for a visitor to a website to provide a comment in response to pre-determined queries and categories associated with the electronic content of the website. It further provides for additional context that describes the viewpoint of that visitor, and allows the analysis of all visitor-submitted comments that have been saved in the database, in order to produce a synthesis summary text, chart visualizations, and a contextual grid-like sorting of the comments for display. Advantageously, the synthesis and sorting provide new visitors with a unique way to quickly comprehend the essential information of a large number of comments without having to read every single comment.

In order that the present invention may be fully understood and readily put into practical effect, there shall now be described by way of non-limitative examples only preferred embodiments of the present invention, the description being with reference to the accompanying illustrative figures.

### BRIEF DESCRIPTION OF THE DRAWINGS

FIG. 1 is a flowchart of a method according to an embodiment of the present invention;

FIG. 2 is a form for a commenter's input according to an embodiment of the present invention;

FIG. 3 is a flow diagram of the method and system according to an embodiment of the present invention;

FIG. 4 is a representation according to an embodiment of the present invention; and

FIG. 5 is representation according to another embodiment of the present invention.

### DETAILED DESCRIPTION OF CERTAIN EXEMPLARY EMBODIMENTS

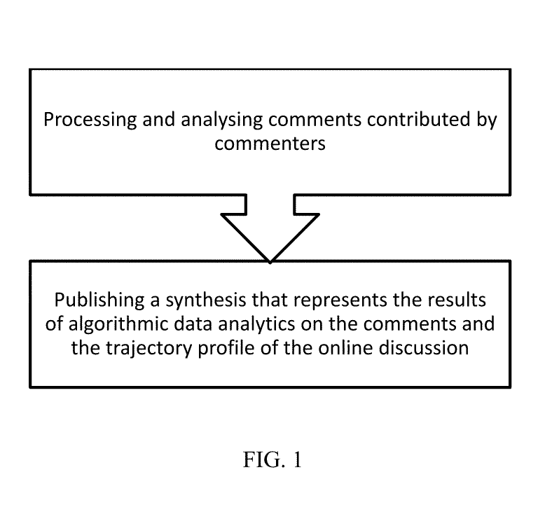

FIG. 1 shows a general scheme of the present invention. It includes a system and method for processing and analysing comments that are associated with an electronic content, and providing a synthesis that presents the results of algorithmic data analytics on the comments. More particularly, the synthesis provides for a system and method that includes one or more processor that is programmed, adapted or configured to assign a comment provided by a commenter (or a user of the system) to one of at least two options, the at least two options relate to at least two potential viewpoints associated with the electronic content. The steps of processing and analysing the comments and preparing the synthesis of the processed comments is described in a non-limiting example is described below.

One application of the invention is as a replacement for such commenting systems on personal, commercial, and news or magazines websites, where a visitor can leave a viewpoint on a particular question or topic being discussed by other visitors. The invention could be designed as a “plug-in” (a standalone piece of software that can be inserted with minimal effort) to any website that seeks to invite comments from visitors.

Using debate and argumentation theory, a topic for discussion as represented in an electronic can have many viewpoints. For example, these viewpoints may be represented by “options” and, within each “option”, “categories”. These “options” may also be known as “sides”, “opinions”, “perspectives” or the like. For example, a topic for discussion may be “Should we do policy ABC?”. Such a topic may be considered an electronic content that can elicit responses from commenters. Of course, it is understood by the skilled person that the topic may be accompanied by further content to further provide context and explain the topic for discussion. Collectively, they may be known as electronic content.

The “options” may be a close-ended and direct answer to the discussion question. As such, in the example given above, possible option are: “yes” or “no”. Further examples include, in response to the topic “XYZ is the best Italian restaurant”, possible option are: “agree” or “disagree”; in response to a product comparison of best mobile phone operating systems, possible sides could be: “iOS”, “Windows”, and “Android”). The “category” is the grounds on which the opinion is argued. For example, a visitor who “disagrees” that with the topic “This is the best product” may feel so because of the price of the product, the quality of the product, or the reliability of the product. Thus the price, quality, and reliability are thus three different ‘categories’ of the opinion. Finally, the content of the opinion contains the actual text of the comment that the visitor wishes to submit, which could explain or describe why a visitor holds that viewpoint. In an embodiment, “column” and “row” could be used to describe the “option” and “category” respectively. The use of the term “option” and “category” are just one embodiment of the invention and alternative terms may be used to describe them. The terms “option” and “side” may be used interchangeably.

For the purposes of example only, in one possible embodiment, the attached figures and description below will explain the invention on a website that poses the hypothetical question, “Should Boston vote for Candidate X?” where there are two possible options (“Yes” and “No”) and three possible pre-determined categories for the viewpoints (“X's Character”, “X's Capabilities”, and “X's Track Record”). This is purely used as an illustrative example for the purposes of subsequent explanation, and does not in any way limit or exhaustively describe the other possible embodiments, discussion prompts, topics, questions, options, sides, or categories of the invention.

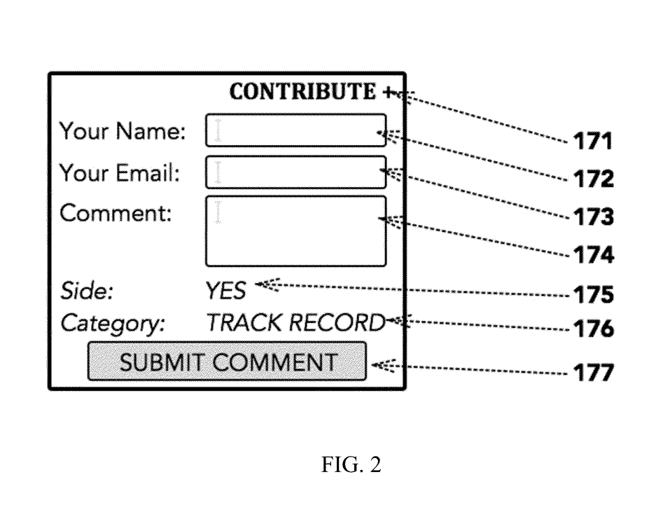

Referring now to the invention in more detail. FIG. 2 depicts one embodiment of a method of input for the invention, whereby a visitor can submit a comment (and, hence the visitor is a commenter) to the website using a structured input form that captures the viewpoint (side, category, and comment) of the visitor in response to the discussion question. The invitation to contribute is a web submission form and is shown in FIG. 1 as the entire boxed element 171. The visitor (also known as the ‘user’) can input their name in the blank text input field 172, their email address in the blank text input field 173, and their comment in the blank text field 174. In an alternative embodiment, the visitor may be asked to provide other identification information, such as social media login credentials.

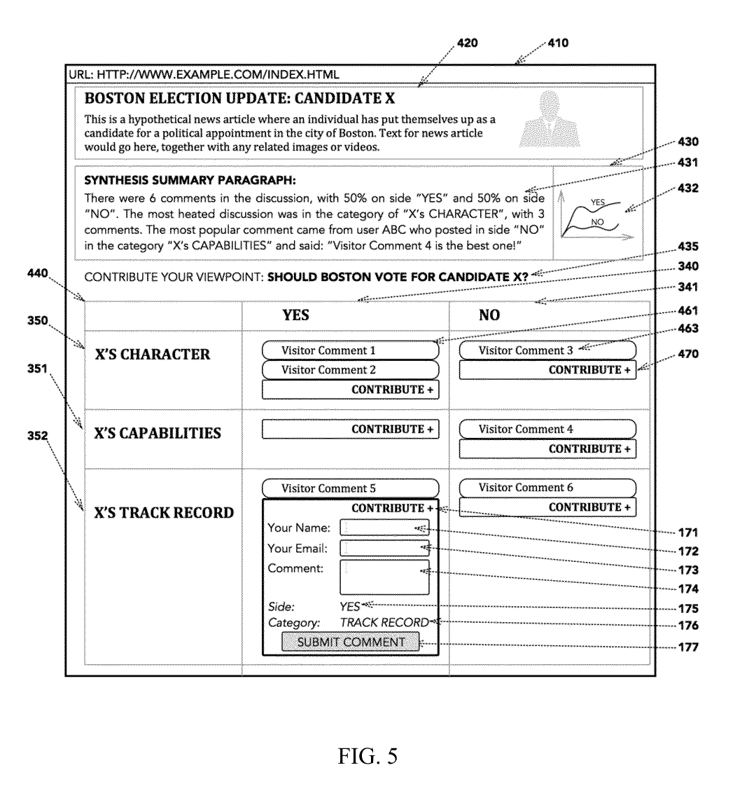

Continuing with the details of FIG. 2, the invention adds two fields that are not found in present commenting systems, the “side” 175 and “category” 176. The purpose of these two fields will be explained subsequently. There are multiple ways in which 175 and 176 may be determined by the invention. In one embodiment, the software could perform algorithmic text analysis on the comment to automatically determine the “side” and “category”. That is, the user can just leave a text comment (as per the norm today) and the algorithm will analyse the text (i.e., it will “read” the words written) and automatically determine that the user is in “agree” and “category b”. This “automatic determination” is known as algorithmic text analysis. In another embodiment, the form may be placed into a grid where the various possible “options” or “sides” are the columns, and the various possible “categories” are the rows, which would then allow the software to determine the “side” and “category” depending on which grid square the visitor has chosen to submit their comment (which will be explained in further detail in FIG. 5). As an example, if a user leaves a comment on a website debating a new tax on small businesses: “I totally do not think that we should enforce this policy because as a small business owner myself, I know that it will cause a lot of negative impact.” A computer can process those words and determine that (1) the user is on side DISAGREE (“do not think we should enforce . . . ”) and (2) the user is in category BUSINESS OWNER (“as a business owner myself”). More sophisticated text analytics could use subtle linguistic cues to determine the side and category of each comment automatically.

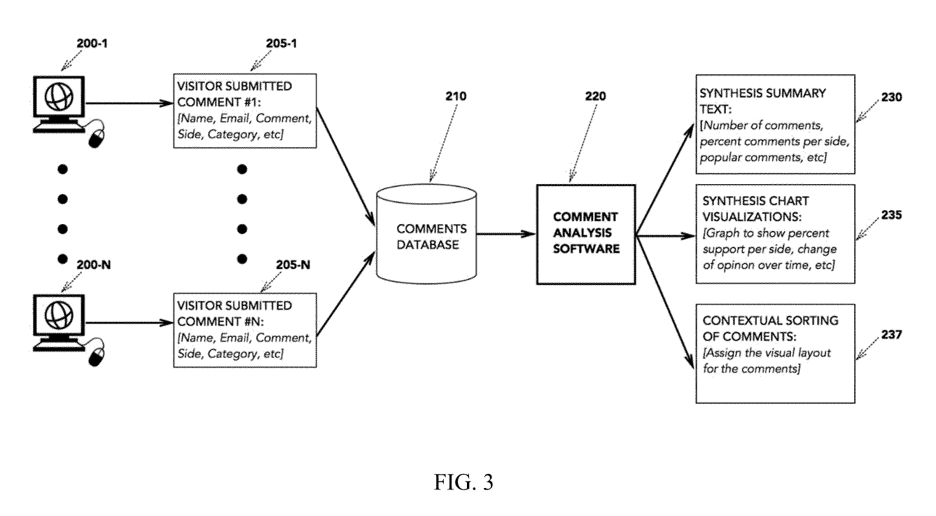

In yet another embodiment, the visitor can be presented with specific input fields that allow them to select their “side” and “category” directly using drop-down menus or other similar selection options. The invention will then record the “side” and “category” data fields. The visitor then clicks the “SUBMIT COMMENT” 177 button, which sends all the necessary data fields (including, but not limited to the fields described above) of the comment to the database and then undergoes the process shown in FIG. 3. There are other possible embodiments of methods of visitor input of a comment with “side” and “category” information to a database.

Turning now to FIG. 3, which depicts a flow diagram of the system that analyses the content of all the visitor-submitted comments stored in the comment database and produces a summary synthesis of the comments for the invention. For each visitor to the website, the web browser will create an instance of the website on their browser as represented by 200-1. The individual visitor may choose to submit a comment to the website, containing the data including but not limited to the name, email, comment, side, and category, of the comment. This individual comment is represented by 205-1. The comment is then stored (saved) to a web server's comments database 210. This database could either be hosted on the same web server as the actual web site being viewed, or it could be stored on a remote web server separate from the content of the web site. This data pathway from 200-1 to 205-1 to 210 represents the pathway for a single comment by a single visitor. For any website, there can be multiple visitors to the website (either simultaneously or at different times). This would create multiple instances of the website rendered on to each visitor's web browser, and is diagrammatically represented on FIG. 3 by the four vertical dots extending to the icon 200-N, which refers to the “n”th visitor's web browser instance of the website. Each of these visitors can leave a comment, or a single visitor can leave multiple comments on a web page. The flow of the comments would be 200-N to 205-N to 210 for each of those individual comments. The comments database 210 thus contains all the saved data of all the comments that have been submitted by all the visitors to that website.

As further shown in FIG. 3, the comment analysis software 220, which is a key component of the invention, is then able to analyze all the comments from the comments database 210. This analysis includes but is not limited to basic operations such as counting the number, proportion, and popularity of comments in each side and category, and also more advanced operations such as calculating the impact of each individual argument on the trajectory of the overall discussion. The analysis can also be determined through algorithmic processes whether the comments were able to persuade users who initially held opposing views, whether only users who were predisposed to that view were persuaded, or whether the comment was unpersuasive to most users. The system can process all the comments received for that conversation to determine which comments had the most significant impact on other users, which users were opinion leaders or shapers (their comments have significant impact on any conversation they partake in), or which conversation topics tend to be the most divergent or convergent. These calculations are used in the automatic generation of a summary synthesis paragraph 230, which describes the key data points in a human-readable format. Additionally, some data can be presented in the form of a visualization 235—such as a chart—that could help a visitor understand those key metrics and data points of the whole conversation. The graphs include, but are not limited to, information on the number of arguments raised on either side, the frequency of rebuttal comments, the shift in opinion over time, and so on. Thus, the automated analysis and synthesis of the comments is achieved by the invention.

The comment analysis software 220 also determines the contextual sorting of comments 237 into the grid-based layout, by analyzing the content of the comment data and assigning a specific position to each comment on the grid-based layout.

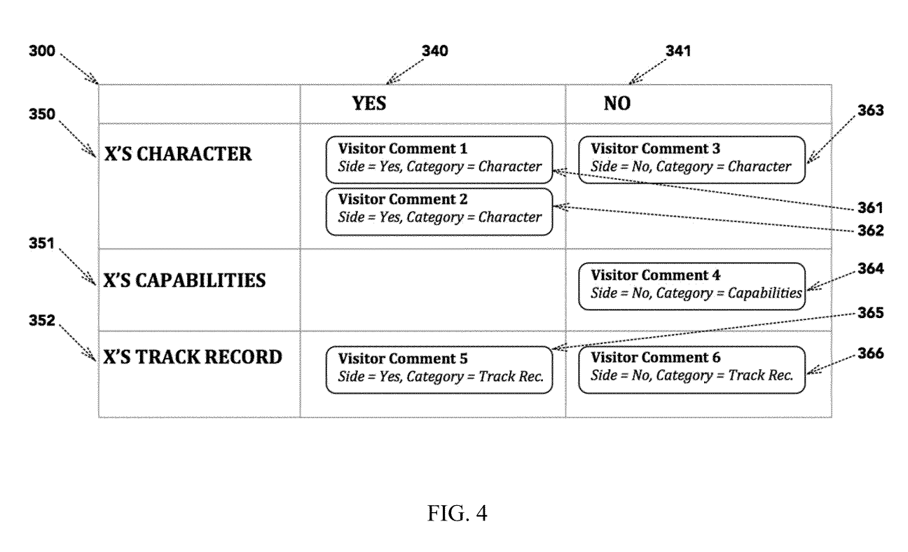

Turning now to FIG. 4, which illustrates the grid-based layout of the comments as a result of the comment analysis software from FIG. 2 220. A grid 300 is first created. Each side in the discussion is represented as a column, so for our example discussion, “YES” is column 340, and “NO” is column 341. Each category is represented as a row, so “X's Character” is row 350, “X's Capabilities” is row 351, and “X's Track Record” is row 352. Each comment has data that includes the side and category of the comment (as described in FIGS. 2, 175 and 176), which the comment analysis software (FIG. 3, 220) uses to determine where to place each individual comment (FIG. 3, 205-1 through to 205-N) in the grid.

In further detail for FIG. 4, sample comments have been laid out in the grid based on the context of their side and category. For example, comment 361 contains data that indicates that the ‘side’ is “yes” and the ‘category’ is “X's Character” (shortened to just “character” in the diagram). The comment also contains other data such as the name of the commenter, the email address, and other information that is not shown as it is not relevant to the sorting algorithm. As such, comment 361 is placed under column 340 because the side of this comment is the same as the side of the column and it is placed in row 350 because the category of this comment is the same as the category of the row. Likewise, for example comments 362 to 366, they are sorted into the respective columns and rows based on the context of each comment's “side” and “category”. Thus the contextual sorting of comments is achieved by the invention.

Turning now to the details of FIG. 5, which illustrates the method of display of the output from the comment analysis software to a visitor's web browser 410 for our example website. In the example, the headline and title of the website and the necessary article content (text, images, videos) are illustrated in the section labeled 420.

The comment analysis software (FIG. 2, 220) produces as one of the output an automatic summary synthesis text 230. This text can then be displayed on the website as illustrated in 430. In one embodiment, the text could contain a human-readable summary text-based paragraph of the entire conversation and describe to a visitor the key metrics of all the comments in the database (such as the winning side, the most popular comment, and other relevant data points as determined by the comment analysis software 220 in the form of a text summary, for example: “This discussion on Topic X received 50 comments, with 24 in Support and 26 Against. The most heated discussion was in category Perspective A and the most persuasive comment was from user B who stated DEF.”). This text summary would provide users a short summary of a large number of comments, using data from the synthesis. In FIG. 5, next to the synthesis text is a chart 432, which is the graphical depiction of the output 235 of the synthesis chart visualization. In one embodiment, the chart could present data on the percentage of arguments or votes on each side. In another embodiment, a chart could be drawn on the support for each side over time. There are other possible embodiments where a visual chart graphic is used to present some of the analysis output that is easier to depict using charts or other graphical forms.

The algorithm looks at the pattern of votes received to determine how persuasive or contentious the comment is. The algorithm also counts all the comments on each side, in each row, and works out the weighted percentages to give a “score” to each side and each row.

Continuing with the details of FIG. 5, this specific embodiment uses a discussion question that prompts the visitor to provide comments as depicted in 435. In other embodiments, the invitation for visitors to comment could come in the form of a topic phrase, or a comparison of different products, services, or ideas that can be commented upon.

The comments from the database are displayed in the website according to the grid layout as determine by the comment analysis software (FIG. 3, 220) and as described for FIG. 4. In this embodiment, the visual layout shown in the grid 440 is based on the layout of the grid 300, with the comments being sorted contextually into the various columns and rows as previously described. In alternative embodiments, the web designer may choose to alter the fonts, size, or visual layout of the comments, so long as it is clear which side and category each displayed comment falls under, as determined by the invention. In the example, when the data contained in comment 363 is rendered to the web browser as comment 463, the designer of the website may choose to display the comment without displaying the “side” or “category” as those can be inferred by the visitor based on the location of the comment in the grid. In other embodiments, other minor changes may be made to the visual display of comment 463, such as the inclusion of the comment author's name, email, or other data that is saved together with the comment. The key element of the invention is that each comment is associated with a “side” and a “category”, and all comments are sorted and displayed based on that relationship to these two fields.

Continuing with the details of FIG. 5, visitors are able to submit comments to the website should they wish to do so. In this specific embodiment, each grid square in the grid-based layout of comments contains a box that looks similar to 470 labeled “CONTRIBUTE +”. In one embodiment, when a visitor clicks the link, a popup window or overlay could appear with a comment submission form. In another embodiment, the smaller box 470 could expand to a full form similar in appearance to FIG. 2. In this embodiment, the submission form must capture the column information (“side” as shown in 175) and row information (“category” as shown in 176) of the visitor's comment so that the context of the comment can be saved together with the other data upon submission of the comment. This information can be displayed or it can be hidden (embedded in the code of the website but not visible to the visitor). The visitor-submitted comment is added to the comment database and then undergoes the process as described above for FIG. 2.

The advantages of the present invention include, without limitation, the ability for a new visitor to quickly and easily see a summary of a large number of comments on a web page without having to read every single comment. This summary will aid their comprehension and is a unique value proposition as compared to present commenting systems, which lack similar automatic summary features. Furthermore, the automated analysis and synthesis can provide an immediate data feedback (in terms of the calculated data presented in 431) to a visitor on which side and category in the debate are the most popular or best-supported by other commenting visitors. This will educate them on whether their own viewpoints are consistent with the majority or minority opinion. The invention is also a useful way to auto-generate additional articles and stories for a website through visitor comments. In one application, it could be a method to create a crowd-sourced article that responds to the main content, by analyzing the comments database and creating an article (using the same processing algorithm that creates the text paragraph synthesis described above) that may rebut or agree with the original article or electronic content created by the website owner(s).

Further advantages of the present invention include the ability for a new visitor to the website to see comments sorted in a grid-based layout, which allows easier visual comparison between similar or related comments on opposite sides, or from different categories on the same side. For example, a visitor can directly compare comments 461 and 463, which are both in the same category of “X's Character” but on opposing sides. This is not possible with present commenting systems, as comments are only sortable by chronology or by rank-order (through peer-voting).

While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

We claim:

1. A system for processing online comments associated with electronic content, the system comprising one or more processor that is configured to assign a comment to one of at least two options, the at least two options relate to at least two potential viewpoints associated with the electronic content.

2. The system according to claim 1, wherein the one or more processor is further configured to determine a profile of a commenter by determining:
(a) if the commenter's comment receives a response from at least one respondent and, if it does, analysing said response, the analysis comprising:
(i) if the response is a vote to agree or disagree, determining the number of votes; and/or
(ii) if the response is a further comment, determining which option the respondent's comment belongs to.

3. The system according to claim 2, wherein the one or more processor is further configured to determine whether the voter providing the vote had provided a comment, and determining which option said comment belongs to.

4. The system according to claim 1, wherein the one or more processor provides the at least two options to a commenter for the commenter's selection and the commenter assigns his comments to one of the at least two options.

5. The system according to claim 1, wherein each option further comprising at least one pre-determined category associated with the option.

6. The system according to claim 5, wherein the one or more processor is configured to further assign the comment to a pre-determined category.

7. The system according to claim 5, wherein the one or more processor is configured to provide the at least one pre-determined category for the commenter's selection and the commenter assigns his comment to one pre-determined category.

8. The system according to claim 5, wherein the one or more processor is further configured to provide a representation of the processed comments.

9. The system according to claim 8, wherein the representation comprising:
(a) a grid having columns and rows; and
(b) each column represents an option and each row represents a category,
wherein a comment that corresponds to the respective column and row is assigned a position in the grid.

10. The system according to claim 1, wherein the one or more processor is further configured to determine the results and trajectory profile of the online discussion and provide a representation thereof.

11. The system according to claim 1, wherein the system further comprising a database of pre-determined keywords and assigning of the comment to the option or pre-determined category is based on the pre-determined keywords.

12. A method for processing online comments associated with electronic content, the method comprising assigning a comment to one of at least two options, the at least two options relate to at least two potential viewpoints associated with the electronic content.

13. The method according to claim 12, further comprising determining a profile of a commenter by determining:
(a) if the commenter's comment receives a response from at least one respondent and, if it does, analysing said response, the analysis comprising:
(i) if the response is a vote to agree or disagree, determining the number of votes; and/or
(ii) if the response is a further comment, determining which option the respondent's comment belongs to.

14. A method according to claim 13, further comprising determining whether the voter providing the vote had provided a comment, and determining which option said comment belongs to.

15. The method according to claim 12, comprising providing the at least two options to a commenter for the commenter's selection and the commenter assigns his comments to one of the at least two options.

16. The method according to claim 12, wherein each option further comprising at least one pre-determined category associated with the option, and assigning the comment to the pre-determined category.

17. The method according to claim 12, further providing a representation of the processed comments.

18. The method according to claim 17, wherein the representation comprising:
(a) a grid having columns and rows; and
(b) each column represents an option and each row represents a category,
wherein a comment that corresponds to the respective column and row is assigned a position in the grid.

19. The method according to claim 12, further comprising determining the results and trajectory profile of the online discussion and provide a representation thereof.

20. A computer readable medium having instructions stored therein, the instructions when executed on a machine cause the machine to perform the method of claim 12.
